(19) United States
(12) Patent Application Publication
(10) Pub. No.: US 2025/0060620 A1
(43) Pub. Date: Feb. 20, 2025

(54) OPTICAL DEVICE, OPTICAL TRANSMITTER, AND OPTICAL TRANSCEIVER

(71) Applicant: FUJITSU OPTICAL COMPONENTS LIMITED, Kawasaki-shi (JP)

(72) Inventors: Masaki SUGIYAMA, Kawasaki (JP); Suguru AKIYAMA, Kawasaki (JP)

(73) Assignee: FUJITSU OPTICAL COMPONENTS LIMITED, Kawasaki-shi (JP)

(21) Appl. No.: 18/765,935

(22) Filed: Jul. 8, 2024

(30) Foreign Application Priority Data
Aug. 14, 2023 (JP) 2023-132137

(51) Int. Cl. G02F 1/035

(52) U.S. Cl. CPC G02F 1/0356

(57) ABSTRACT

An optical device has a first chip including a first waveguide and a first electrode, and a second chip mounted on the first chip and including a second waveguide and a second electrode. The second waveguide has an electro-optic effect higher than an electro-optic effect of the first waveguide and has a return structure that places an end of the second waveguide at an end face of the second chip. The second waveguide has been optically coupled to the first waveguide at the end face. The second electrode has a return structure that places an end of the second electrode at the end face, and the second electrode and the first electrode are electrically connected to each other in an area where the end of the second electrode has been placed.

### CROSS-REFERENCE TO RELATED APPLICATION

This application is based upon and claims the benefit of priority of the prior Japanese Patent Application No. 2023-132137, filed on Aug. 14, 2023, the entire contents of which are incorporated herein by reference.

### FIELD

The embodiments discussed herein are related to optical devices, optical transmitters, and optical transceivers.

### BACKGROUND

A conventional optical modulator has, for example, optical waveguides provided on a substrate, and a signal electrode and ground electrodes that are arranged near the optical waveguides. In response to application of a voltage to the signal electrode, electric fields are generated in the optical waveguides, refractive indices of the optical waveguides are changed by the electric fields in the optical waveguides, and phases of light are changed. The optical waveguides form a Mach-Zehnder interferometer and optical output is changed by a difference between the phases of light in the optical waveguides.

Optical modulators are, for example, Mach-Zehnder modulators. FIG. 34 is a planar schematic diagram illustrating an example of a conventional optical modulator 200. The optical modulator 200 includes, for example, a thin film lithium niobate (LiNbO₃: LN) chip. The optical modulator 200 has an input waveguide 221, a splitter 222, a radio frequency (RF) modulation unit 223, a direct current (DC) modulation unit 224, a multiplexer 225, and an output waveguide 226. The input waveguide 221 is, for example, an LN waveguide 215 where signal light is input. The splitter 222 splits the signal light from the input waveguide 221 into two optical waveguides 223A in the RF modulation unit 223. The RF modulation unit 223 is a modulation unit where the signal light guided through the two optical waveguides 223A is subjected to high speed modulation.

The RF modulation unit 223 has the two optical waveguides 223A arranged parallel to each other and plural RF electrodes 223B arranged parallel to the two optical waveguides 223A. The two optical waveguides 223A are LN waveguides 215. The RF electrodes 223B include two ground electrodes 214B arranged parallel to each other outside the two optical waveguides 223A and one signal electrode 214A arranged between the two optical waveguides 223A and parallel to the optical waveguides 223A. In a case where a high frequency signal having a band of a few tens of GHz has been input to the signal electrode 214A, the RF modulation unit 223 enables the signal light guided through the optical waveguides 223A to be subjected to the high speed modulation according to the high frequency signal.

FIG. 35 is a sectional schematic diagram illustrating an example of a cross section on a line A-A illustrated in FIG. 34. The cross section on the line A-A is of the RF modulation unit 223 in the optical modulator 200. The RF modulation unit 223 illustrated in FIG. 35 has: a support substrate 211 of Si, for example; an intermediate layer 212 formed on the support substrate 211; a thin film LN substrate 213 formed on the intermediate layer 212; and electrodes 214 formed on the thin film LN substrate 213. The thin film LN substrate 213 has the thin film LN waveguides 215 protruding upward. The LN waveguides 215 are each a rib waveguide having a rib and a slab formed on both sides of the rib. The electrodes 214 have the signal electrode 214A and the pair of ground electrodes 214B. A surface on the slab has, arranged thereon, the electrodes 214 having a coplanar waveguide (CPW) structure, that is, the signal electrode 214A and the pair of ground electrodes 214B with the signal electrode 214A between the pair of ground electrodes 214B. The electrodes 214 in the RF modulation unit 223 are the RF electrodes 223B.

The two optical waveguides 223A in the RF modulation unit 223 are connected to two optical waveguides 224A in the DC modulation unit 224 and the DC modulation unit 224 is a modulation unit that modulates signal light guided through the two optical waveguides 224A in the DC modulation unit 224. The multiplexer 225 multiplexes the signal light from the two optical waveguides 224A in the DC modulation unit 224 together. The output waveguide 226 is an LN waveguide 215 that outputs the signal light from the multiplexer 225, the signal light having been multiplexed.

The DC modulation unit 224 has the two optical waveguides 224A arranged parallel to each other and plural DC electrodes 224B arranged parallel to the two optical waveguides 224A. The two optical waveguides 224A are LN waveguides 215. The DC electrodes 224B include: two ground electrodes 214B arranged parallel to each other outside the two optical waveguides 224A; and one signal electrode 214A arranged between the two optical waveguides 224A and parallel to the optical waveguides 224A. In a case where a bias voltage has been applied to the signal electrode 214A, the DC modulation unit 224 adjusts a bias to turn on and off the signal light guided through the optical waveguides 224A, according to an on-state or an off-state of the bias voltage. The DC modulation unit 224 also has a support substrate 211, an intermediate layer 212, a thin film LN substrate 213, and electrodes 214. The electrodes 214 in the DC modulation unit 224 are the DC electrodes 224B. That is, both the RF modulation unit 223 and the DC modulation unit 224 are formed of a thin film LN chip.
Patent Literature 1: International Publication Pamphlet No. WO 2007/058366
Patent Literature 2: U.S. Patent Application Publication No. 2017/0285437
Patent Literature 3: Japanese Laid-open Patent Publication No. 2005-221874

If the bias voltage continues to be applied to the DC electrodes 224B, intensity of light output by the DC modulation unit 224 of the optical modulator 200 changes over time due to a DC drift (a change over time in emitted light, the change being caused by the bias voltage applied). The bias voltage needs to be increased to compensate for this change. However, control is lost when the bias voltage reaches the maximum voltage of the control power source.

Using heater electrodes instead of the DC electrodes 224B in the DC modulation unit 224 can thus solve this problem due to the DC drift. When an electric current is passed through the heater electrodes provided on the optical waveguides 224A via a buffer layer, heat generated in the heater electrodes raises temperature of the optical waveguides 224A. As a result, the refractive indices of the optical waveguides 224A are changed by the thermo-optical effect and the phases of the signal light guided through the optical waveguides 224A are thus able to be adjusted.

However, a DC modulation unit using heater electrodes would be formed of a silicon photonics (SiPh) chip, and an RF modulation unit using RF electrodes would be formed of a thin film LN chip. Therefore, there would be a need for a thin film LN chip to be mounted on a SiPh chip to form an optical modulator.

### SUMMARY

According to an aspect of an embodiment, an optical device includes a first chip including a first waveguide and a first electrode, and a second chip mounted on the first chip and including a second waveguide and a second electrode. The second waveguide has an electro-optical effect higher than an electro-optical effect of the first waveguide, has a return structure that places an end of the second waveguide at an end face of the second chip, and is optically coupled to the first waveguide at the end face. The second electrode has a return structure that places an end of the second electrode at the end face. The second electrode and the first electrode are electrically connected to each other in an area where the end of the second electrode has been placed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a planar schematic diagram illustrating an example of an optical modulator according to a first embodiment;

FIG. 2 is a sectional schematic diagram illustrating an example of a cross section on a line A-A illustrated in FIG. 1;

FIG. 3 is a sectional schematic diagram illustrating an example of a cross section on a line B-B illustrated in FIG. 1;

FIG. 4 is a planar schematic diagram illustrating an example of an optical modulator according to a second embodiment;

FIG. 5 is a sectional schematic diagram illustrating an example of a cross section on a line A-A illustrated in FIG. 4;

FIG. 6 is a sectional schematic diagram illustrating an example of a cross section on a line B-B illustrated in FIG. 4;

FIG. 7 is a planar schematic diagram illustrating an example of an optical modulator according to a third embodiment;

FIG. 8 is a sectional schematic diagram illustrating an example of a cross section on a line A-A illustrated in FIG. 7;

FIG. 9 is a sectional schematic diagram illustrating an example of a cross section on a line B-B illustrated in FIG. 7;

FIG. 10 is a planar schematic diagram illustrating an example of an optical modulator according to a fourth embodiment;

FIG. 11 is a sectional schematic diagram illustrating an example of a cross section on a line A-A illustrated in FIG. 10;

FIG. 12 is a sectional schematic diagram illustrating an example of a cross section on a line B-B illustrated in FIG. 10;

FIG. 13 is a planar schematic diagram illustrating an example of an optical modulator according to a fifth embodiment;

FIG. 14 is a sectional schematic diagram illustrating an example of a cross section on a line A-A illustrated in FIG. 13;

FIG. 15 is a sectional schematic diagram illustrating an example of a cross section on a line B-B illustrated in FIG. 13;

FIG. 16 is a planar schematic diagram illustrating an example of an optical modulator according to a sixth embodiment;

FIG. 17 is a sectional schematic diagram illustrating an example of a cross section on a line A-A illustrated in FIG. 16;

FIG. 18 is a sectional schematic diagram illustrating an example of a cross section on a line B-B illustrated in FIG. 16;

FIG. 19 is a planar schematic diagram illustrating an example of an optical modulator according to a seventh embodiment;

FIG. 20 is a sectional schematic diagram illustrating an example of a cross section on a line A-A illustrated in FIG. 19;

FIG. 21 is a sectional schematic diagram illustrating an example of a cross section on a line B-B illustrated in FIG. 19;

FIG. 22 is a planar schematic diagram illustrating an example of an optical modulator according to an eighth embodiment;

FIG. 23 is a sectional schematic diagram illustrating an example of a cross section on a line A-A illustrated in FIG. 22;

FIG. 24 is a sectional schematic diagram illustrating an example of a cross section on a line B-B illustrated in FIG. 22;

FIG. 25 is a planar schematic diagram illustrating an example of an optical modulator according to a ninth embodiment;

FIG. 26 is a sectional schematic diagram illustrating an example of a cross section on a line A-A illustrated in FIG. 25;

FIG. 27 is a sectional schematic diagram illustrating an example of a cross section on a line B-B illustrated in FIG. 25;

FIG. 28 is a diagram illustrating an example of an optical transceiver according to an embodiment;

FIG. 29 is a planar schematic diagram illustrating an example of an optical modulator according to a comparative example;

FIG. 30 is a sectional schematic diagram illustrating an example of a cross section on a line A-A illustrated in FIG. 29;

FIG. 31 is a sectional schematic diagram illustrating an example of a cross section on a line B-B illustrated in FIG. 29;

FIG. 32 is a sectional schematic diagram illustrating an example of a cross section on a line C-C illustrated in FIG. 29;

FIG. 33 is a sectional schematic diagram illustrating an example of a cross section on a line D-D illustrated in FIG. 29;

FIG. 34 is a planar schematic diagram illustrating an example of a conventional optical modulator; and

FIG. 35 is a sectional schematic diagram illustrating an example of a cross section on a line A-A illustrated in FIG. 34.

### DESCRIPTION OF EMBODIMENTS

### (a) Comparative Example

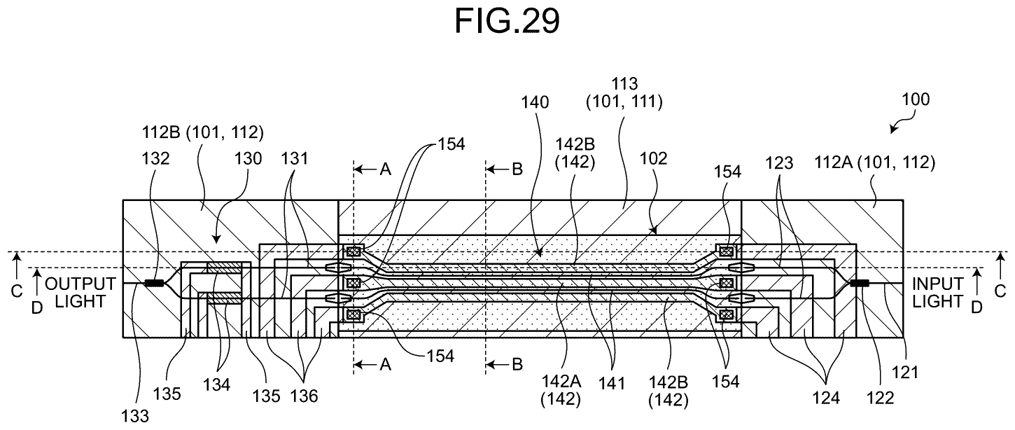

FIG. 29 is a planar schematic diagram illustrating an example of an optical modulator 100 according to a comparative example. The optical modulator 100 illustrated in FIG. 29 has: a SiPh chip 101 having a DC modulation unit 130 mounted thereon, the DC modulation unit 130 including heater electrodes 135; and a thin film LN chip 102 having an RF modulation unit 140 mounted thereon, the RF modulation unit 140 including RF electrodes 142.

The SiPh chip 101 has a Si substrate 111, an oxide layer 112 on the Si substrate 111, and an opening portion 113 that is an opening provided in part of the oxide layer 112. The opening portion 113 is a portion where the thin film LN chip 102 is mounted. The oxide layer 112 has a first oxide layer 112A and a second oxide layer 112B.

The first oxide layer 112A has a Si waveguide 121 near an input, a splitter 122, two Si waveguides 123 near the input, electrodes 124 near the input, and SiN waveguides 125 near the input. The Si waveguide 121 near the input is a Si waveguide where signal light is input. The splitter 122 is connected to the Si waveguide 121 near the input, is also connected to the two Si waveguides 123 near the input, and splits and outputs the signal light input from the Si waveguide 121 near the input, into the two Si waveguides 123 near the input. The two Si waveguides 123 near the input are connected to the splitter 122, are also connected to the SiN waveguides 125 near the input, and output the signal light split and output from the splitter 122 to input terminals of two LN waveguides 141 in a thin film LN chip 103. The electrodes 124 near the input are, for example, Al electrodes electrically connected to the RF electrodes 142 in the thin film LN chip 103, the RF electrodes 142 being near the input. The SiN waveguides 125 near the input are waveguides connecting between the two Si waveguides 123 near the input and the input terminals of the two LN waveguides 141 in the thin film LN chip 103.

The second oxide layer 112B has two Si waveguides 131 near an output and in the DC modulation unit 130, a multiplexer 132, a Si waveguide 133 near the output, heaters 134 in the DC modulation unit 130, and the heater electrodes 135. The second oxide layer 112B has electrodes 136 near the output and SiN waveguides 137 near the output. The SiN waveguides 137 near the output connect between the two Si waveguides 131 near the output and output terminals of the two LN waveguides 141 in the thin film LN chip 103, and output signal light from the output terminals of the two LN waveguides 141 to the multiplexer 132. The two Si waveguides 131 near the output are connected to the SiN waveguides 137 near the output, are also connected to the multiplexer 132, and output signal light from the SiN waveguides 137 near the output, to the multiplexer 132. The multiplexer 132 is connected to the two Si waveguides 131 near the output, is also connected to the Si waveguide 133 near the output, multiplexes signal light from the two Si waveguides 131 near the output, and outputs the signal light that has been multiplexed, to the Si waveguide 133 near the output. The Si waveguide 133 near the output is a waveguide that outputs the signal light that is from the multiplexer 132 and that has been multiplexed.

The heaters 134 in the DC modulation unit 130 are arranged on the two Si waveguides 131 near the output. The heater electrodes 135 are, for example, Al electrodes electrically connected to the heaters 134. In the DC modulation unit 130, by the heaters 134 being heated according to electric currents from the heater electrodes 135, the signal light guided through the Si waveguides 131 near the output is modulated. The electrodes 136 near the output are, for example, Al electrodes electrically connected to the RF electrodes 142 of the RF modulation unit 140 in the thin film LN chip 103.

The thin film LN chip 103 has the two LN waveguides 141 and the RF electrodes 142 arranged parallel to the two LN waveguides 141, and the two LN waveguides 141 and the RF electrodes 142 form the RF modulation unit 140. The RF electrodes 142 are, for example, Au electrodes. The RF electrodes 142 include one signal electrode 142A and two ground electrodes 142B, and are electrically connected to the electrodes 124 and the electrodes 136 that are in the SiPh chip 101, the electrodes 124 being near the input, the electrodes 136 being near the output.

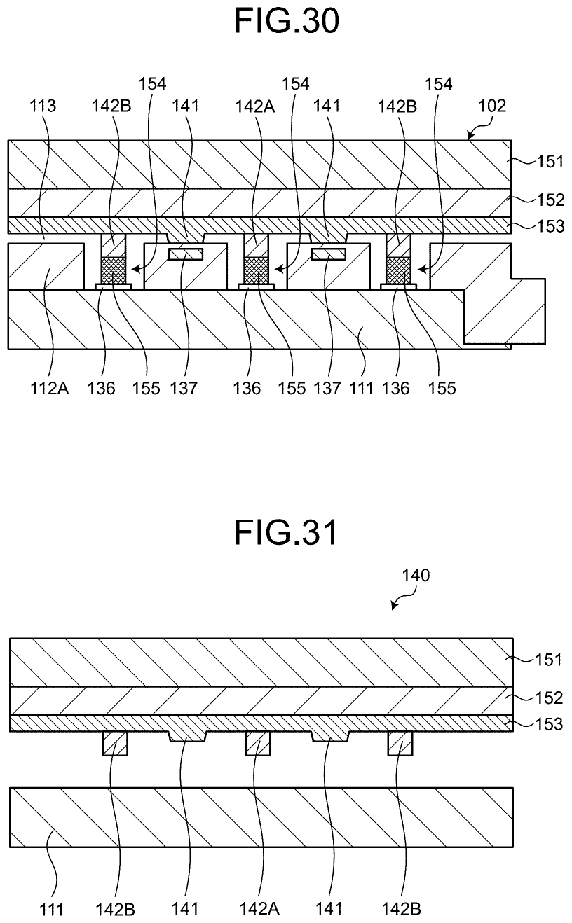

FIG. 30 is a sectional schematic diagram illustrating an example of a cross section on a line A-A illustrated in FIG. 29. The cross section on the line A-A is of a portion where the SiPh chip 101 and the thin film LN chip 102 are joined to each other, the portion being near the second oxide layer 112B. The thin film LN chip 102 has: a support substrate 151 of Si, for example; an intermediate layer 152 of SiO₂, for example, formed on the support substrate 151; and a thin film LN substrate 153 formed on the intermediate layer 152. The thin film LN substrate 153 has the LN waveguides 141 that each have a protruded shape and protrude from a surface of the thin film LN substrate 153, the surface not being the other surface facing the intermediate layer 152.

The LN waveguides 141 are rib waveguides each having a rib and a slab formed on both sides of the rib. The slabs have, arranged on surfaces of the slabs, the RF electrodes 142 having a coplanar waveguide (CPW) structure, that is, the signal electrode 142A and the pair of ground electrodes 142B with the signal electrode 142A between the pair of ground electrodes 142B.

The SiPh chip 101 has the Si substrate 111 and the second oxide layer 112B. The second oxide layer 112B has the SiN waveguides 137 connected to the two Si waveguides 131 near the output. The SiN waveguides 137 are optically connected to the LN waveguides 141 of the thin film LN chip 102.

The electrodes 136 of the SiPh chip 101 and near the output are electrically connected to the RF electrodes 142 of the thin film LN chip 102 via bumps 155 of connection pads 154. That is, a signal electrode of the electrodes 136 near the output is electrically connected to the signal electrode 142A of the RF electrodes 142 via one of the bumps 155 of the connection pads 154. Ground electrodes of the electrodes 136 near the output are electrically connected to the ground electrodes 142B of the RF electrodes 142 via the other bumps 155 of the connection pads 154.

FIG. 31 is a sectional schematic diagram illustrating an example of a cross section on a line B-B illustrated in FIG. 29. The cross section on the line B-B is of the RF modulation unit 140 of the thin film LN chip 102. In a state where the RF modulation unit 140 of the thin film LN chip 102 has been mounted in the opening portion 113 on the Si substrate 111 of the SiPh chip 101, the RF electrodes 142 and the Si substrate 111 are separate from each other.

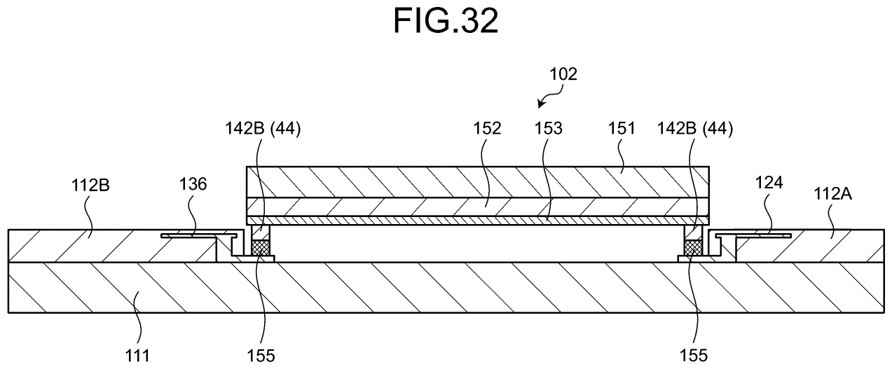

FIG. 32 is a sectional schematic diagram illustrating an example of a cross section on a line C-C illustrated in FIG. 29. At the cross section on the line C-C, the RF electrode 142 arranged on the thin film LN substrate 153 of the thin film LN chip 102 is electrically connected, via bumps 155, to the electrode 124 near the input and the electrode 136 near the output that have been arranged on the Si substrate 111 in the opening portion 113 of the SiPh chip 101.

The electrodes 124 near the input and arranged on the Si substrate 111 near the first oxide layer 112A are electrically connected, via the bumps 155, to the RF electrodes 142 that are near the input and that have been arranged on the thin film LN substrate 153 of the thin film LN chip 102. The electrodes 136 near the output and arranged on the Si substrate 111 near the second oxide layer 112B are electrically connected, via the bumps 155, to the RF electrodes 142 that are near the output and have been arranged on the thin film LN substrate 153 of the thin film LN chip 102.

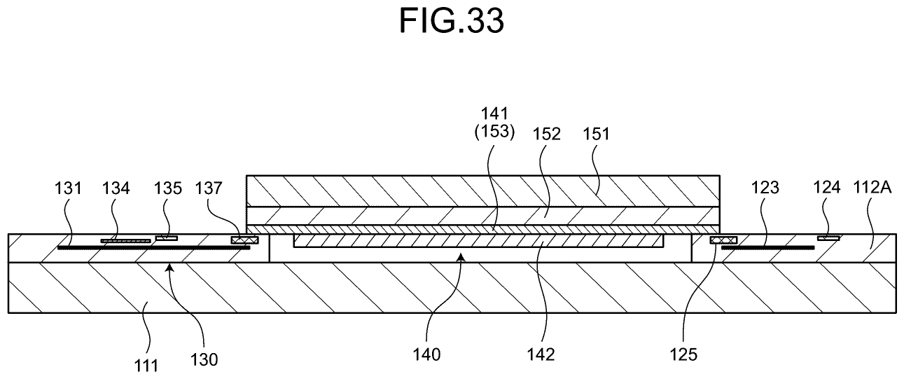

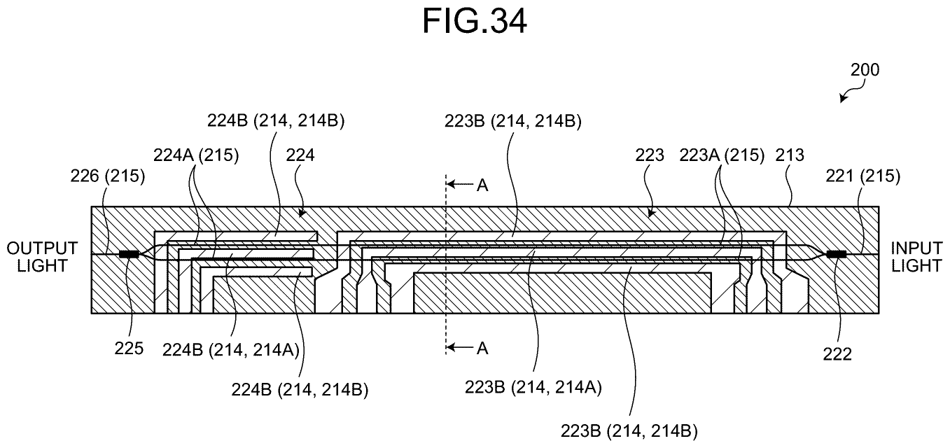

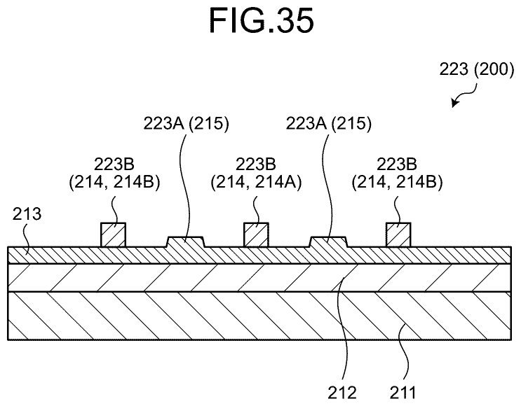

FIG. 33 is a sectional schematic diagram illustrating an example of a cross section on a line D-D illustrated in FIG. 29. The cross section on the line D-D is, for example, at where the Si waveguide 123 near the input, the LN waveguide 141, and the Si waveguide 131 near the output are connected to each other.

The first oxide layer 112A of the SiPh chip 101 has: the electrodes 124 near the input; and the two SiN waveguides 125 that are near the input, are optically connected to the two Si waveguides 123 near the input, and are optically connected to the input terminals of the two LN waveguides 141 of the thin film LN chip 102.

The second oxide layer 112B of the SiPh chip 101 has the two SiN waveguides 137 that are near the output, are optically connected to the two Si waveguides 131 near the output, and are optically connected to the output terminals of the two LN waveguides 141 of the thin film LN chip 102. The second oxide layer 112B also has the heaters 134 arranged on the two Si waveguides 131 near the output, and the heater electrodes 135.

In this comparative example, the thin film LN chip 102 having the RF electrodes 142 is flip-chip bonded facedown to the opening portion 113 dug in part of the oxide layer 112 of the SiPh chip 101 by etching. The RF electrodes 142 of the thin film LN chip 102 are electrically connected to the electrodes 124 (136) of the SiPh chip 101 via the bumps 155. The LN waveguides 141 of the thin film LN chip 102 connect the Si waveguides 123 near the input and the Si waveguides 131 near the output to each other via the SiN waveguides 125 (137) provided in the SiPh chip 101.

However, in the optical modulator 100 according to the comparative example, the connection to the Si waveguides 123 near the input and the connection to the Si waveguides 131 near the output are respectively at two ends of the thin film LN chip 102. As a result, when the thin film LN chip 102 is flip-chip bonded to the opening portion 113 of the SiPh chip 101, adjustment of optical axes between the SiN waveguides and the LN waveguides is needed at both ends of the chip and thus makes the mounting work difficult.

Furthermore, the thin film LN chip 102 has a length of about 10 mm in a longitudinal direction of the LN waveguides 141. As a result, in a case where the thin film LN chip 102 has been fixed to the SiPh chip 101 at both ends of the thin film LN chip 102, stress is generated upon a temperature change, according to a difference between thermal expansions of the thin film LN chip 102 and the SiPh chip 101, and optical output is thus destabilized. That is, even in a case where the optical modulator 100 is formed of the thin film LN chip 102 including the RF modulation unit 140 and the SiPh chip 101 including the DC modulation unit 130, there is still a demand for an optical modulator that enables prevention of destabilization of optical output, the destabilization being caused by generation of stress upon a temperature change.

Preferred embodiments of the present invention will be explained with reference to accompanying drawings. The present invention is not to be limited by the embodiments.

### (b) First Embodiment

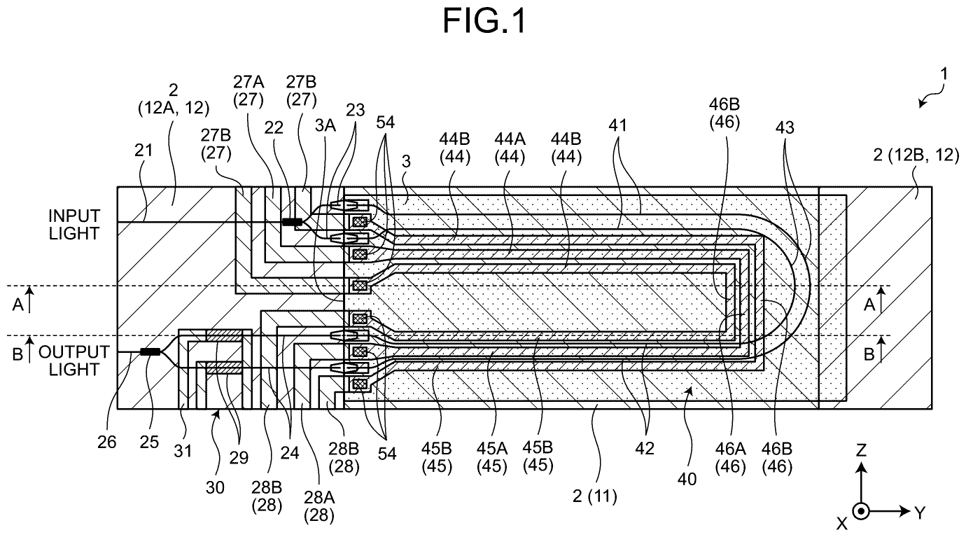

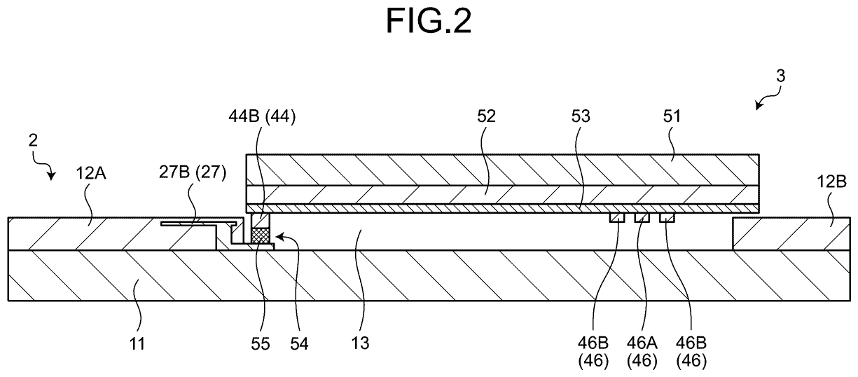

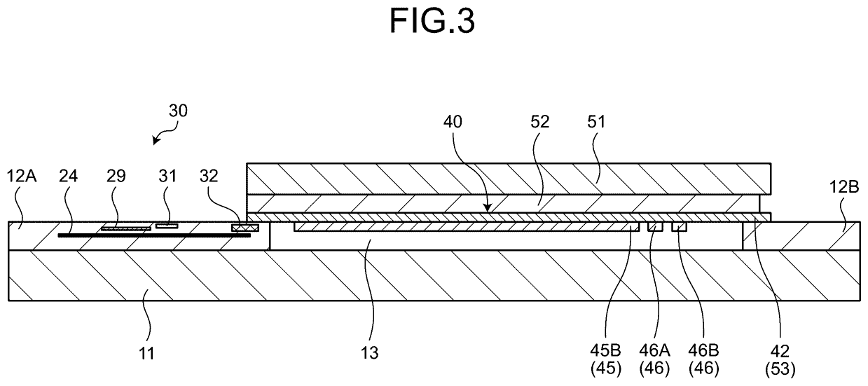

FIG. 1 is a planar schematic diagram illustrating an example of an optical modulator 1 according to a first embodiment, FIG. 2 is a sectional schematic diagram illustrating an example of a cross section on a line A-A illustrated in FIG. 1, and FIG. 3 is a sectional schematic diagram illustrating an example of a cross section on a line B-B illustrated in FIG. 1. The optical modulator 1 illustrated in FIG. 1 is, for example, a Mach-Zehnder modulator. The optical modulator 1 has a SiPh chip 2 having, mounted thereon, a direct current (DC) modulation unit 30 including heater electrodes, and a thin film lithium niobate (LiNbO₃: LN) chip 3 having, mounted thereon, a radio frequency (RF) modulation unit 40 including RF electrodes.

The SiPh chip 2 has: a Si substrate 11; an oxide layer 12 of, for example, SiO₂, formed on the Si substrate 11; and an opening portion 13 that is an opening provided in part of the oxide layer 12. The oxide layer 12 has, via the opening portion 13, a first oxide layer 12A and a second oxide layer 12B. A first chip is, for example, the SiPh chip 2.

The first oxide layer 12A has a Si waveguide 21 near an input, a splitter 22, two Si waveguides 23 near the input, two Si waveguides 24 near an output, a multiplexer 25, and a Si waveguide 26 near the output. The Si waveguide 21 near the input is a waveguide where signal light is input. The splitter 22 is connected to the Si waveguide 21 near the input, is connected to the two Si waveguides 23 near the input, and splits and outputs the signal light input from the Si waveguide 21 near the input, into the two Si waveguides 23 near the input. The two Si waveguides 23 near the input are connected to the splitter 22 and are connected to SiN waveguides 32 described later. The two Si waveguides 23 near the input are connected to input terminals of two LN waveguides 41 that are near the input and that are in the thin film LN chip 3, the input terminals being connected to the SiN waveguides 32, and the two Si waveguides 23 near the input output the signal light split and output from the splitter 22 to the two LN waveguides 41 that are near the input and that are in the thin film LN chip 3.

The two Si waveguides 24 near the output are connected to the SiN waveguides 32 connected to output terminals of two LN waveguides 42 that are near the output and that are in the thin film LN chip 3, are connected to the multiplexer 25, and output signal light from the two LN waveguides 42 near the output, to the multiplexer 25. The multiplexer 25 is connected to the two Si waveguides 24 near the output, multiplexes the signal light from the two Si waveguides 24 near the output together, and outputs the signal light that has been multiplexed together, to the Si waveguide 26 near the output. The Si waveguide 26 near the output is a waveguide that outputs the signal light that has been multiplexed together and has come from the multiplexer 25. First waveguides are, for example, the Si waveguides 23 near the input and the Si waveguides 24 near the output.

The DC modulation unit 30 has the two Si waveguides 24 near the output, heaters 29 arranged on the two Si waveguides 24 near the output, and heater electrodes 31 electrically connected to the heaters 29. In the DC modulation unit 30, signal light guided through the Si waveguides 24 near the output is modulated by: the heaters 29 being heated according to electric currents to the heater electrodes 31; and the Si waveguides 24 near the output thereby being heated. First electrodes are, for example, the heater electrodes 31.

The thin film LN chip 3 has: a support substrate 51 of, for example, Si; an intermediate layer 52 of, for example, SiO₂, formed on the support substrate 51; and a thin film LN substrate 53 formed on the intermediate layer 52. The thin film LN substrate 53 has the LN waveguides 41 and 42 and LN waveguides 43 that each have a protruded shape, are protruded, and are on a surface of the thin film LN substrate 53, the surface not being the other surface facing the intermediate layer 52. The LN waveguides 41, 42, and 43 are rib waveguides each having a rib and a slab formed on both sides of the rib. RF electrodes 44, 45, and 46 having a coplanar waveguide (CPW) structure are arranged on surfaces of the slabs. The RF electrodes 44, 45, and 46 include a signal electrode and a pair of ground electrodes having the signal electrode between the pair of ground electrodes. A second chip is, for example, the thin film LN chip 3 having an electro-optical effect higher than those of the first waveguides.

The thin film LN chip 3 has the LN waveguides 41, 42, and 43 having a return structure and the RF electrodes 44, 45, and 46 having a return structure. In the thin film LN chip 3, ends of both the LN waveguides 41 and 42 are located on a first end face 3A of the thin film LN chip 3 and ends of both the RF electrodes 44 and 45 are also located on the first end face 3A of the thin film LN chip 3.

LN waveguides include the LN waveguides 41 on a forward path, the LN waveguides 42 on a backward path, and the LN waveguides 43 that connect between the LN waveguides 41 on the forward path and the LN waveguides 42 on the backward path, the LN waveguides 43 being U-shaped and being return. As for the LN waveguides, the input terminals of the LN waveguides 41 on the forward path and the output terminals of the LN waveguides 42 on the backward path are both located on the first end face 3A of the thin film LN chip 3. The first end face 3A is an end face of the thin film LN chip 3, the end face being near the first oxide layer 12A of the SiPh chip 2. Second waveguides are LN waveguides, such as, for example, the LN waveguides 41 on the forward path and the LN waveguides 42 on the backward path. Second waveguides on a forward path are, for example, the LN waveguides 41 on the forward path. Second waveguides on a backward path are, for example, the LN waveguides 42 on the backward path.

RF electrodes include the RF electrodes 44 on the forward path, the RF electrodes 45 on the backward path, and the RF electrodes 46 that electrically connect between the RF electrodes 44 on the forward path and the RF electrodes 45 on the backward path, the RF electrodes 46 being U-shaped and being return. As for the RF electrodes, input terminals of the RF electrodes 44 on the forward path and output terminals of the RF electrodes 45 on the backward path are both located on the first end face 3A of the thin film LN chip 3. Second electrodes are, for example, RF electrodes including the RF electrodes 44 on the forward path and the RF electrodes 45 on the backward path. Second electrodes on a forward path are, for example, the RF electrodes 44 on the forward path. Second electrodes on a backward path are, for example, the RF electrodes 45 on the backward path.

The RF electrodes 44 on the forward path include a signal electrode 44A and a pair of ground electrodes 44B arranged parallel to the signal electrode 44A, with the signal electrode 44A between the pair of ground electrodes 44B. The RF electrodes 45 on the backward path include a signal electrode 45A and a pair of ground electrodes 45B arranged parallel to the signal electrode 45A, with the signal electrode 45A between the pair of ground electrodes 45B. The RF electrodes 46 that are return include a signal electrode 46A and a pair of ground electrodes 46B arranged parallel to the signal electrode 46A, with the signal electrode 46A between the pair of ground electrodes 46B.

In a case where the LN waveguides and the RF electrodes have a return structure, returning of the RF electrodes causes the polarity of modulation to be inverted from the LN waveguides 41 on the forward path to the LN waveguides 42 on the backward path, because X-cut LN crystal is used for the thin film LN chip 3. As a result, the modulation before the returning of the return LN waveguides 43 is cancelled after the returning of the return LN waveguide 43. For an electric field of an electric signal to be applied to the LN waveguides only in a case where signal light travels leftward in FIG. 1, the thin film LN chip 3 is structured such that only the LN waveguides 42 on the backward path are influenced by an electric field from the RF electrodes 45 on the backward path, for example. That is, the RF electrodes 45 on the backward path are arranged to apply the electric field from the RF electrodes 45 on the backward path to the LN waveguides 42 on the backward path.

The LN waveguides 41 on the forward path are arranged parallel to the RF electrodes 44 on the forward path, but all of the RF electrodes 44 on the forward path are arranged on an inner peripheral side of the LN waveguides 41 on the forward path. As a result, influence by an electric field applied to the LN waveguides 41 on the forward path from the RF electrodes 44 on the forward path is able to be reduced. That is, the RF electrodes 44 on the forward path are arranged to not apply the electric field from the RF electrodes 44 on the forward path to the LN waveguides 41 on the forward path.

The return LN waveguides 43 are arranged near the return RF electrodes 46, but all of the return RF electrodes 46 are arranged on an inner peripheral side of the return LN waveguides 43. As a result, influence of an electric field applied to the return LN waveguides 43 from the return RF electrodes 46 is able to be reduced.

The LN waveguides 42 on the backward path are arranged parallel to the RF electrodes 45 on the backward path and the signal electrode 45A is arranged between the LN waveguides 42 on the backward path. Furthermore, one of the ground electrodes 45B is arranged for the inner one of the LN waveguides 42 on the backward path, and the other one of the ground electrodes 45B is arranged for the outer one of the LN waveguides 42 on the backward path. That is, the LN waveguides 42 on the backward path are structured to modulate signal light guided therethrough according to the electric field from the RF electrodes 45 on the backward path.

The RF modulation unit 40 has: the two LN waveguides 42 that are on the backward path and are arranged parallel to each other; and the RF electrodes 45 that are on the backward path and are arranged parallel to the two LN waveguides 42 on the backward path. The RF electrodes 45 on the backward path include: the two ground electrodes 45B arranged outside the two LN waveguides 42 on the backward path; and the one signal electrode 45A arranged parallel to the LN waveguides 42 on the backward path and between the two LN waveguides 42 on the backward path. In a case where a high frequency signal having a band of a few tens of GHz has been input to the signal electrode 45A, for example, signal light guided through the two LN waveguides 42 on the backward path are subjected to high speed modulation in the RF modulation unit 40, according to the high frequency signal.

The two Si waveguides 23 near the input and in the first oxide layer 12A are connected to the two LN waveguides 41 on the forward path in the thin film LN chip 3 via the two SiN waveguides 32 near the input. The two Si waveguides 24 near the output and in the first oxide layer 12A are connected to the two LN waveguides 42 on the backward path in the thin film LN chip 3 via the SiN waveguides 32 near the output. That is, the LN waveguides in the thin film LN chip 3 have a return structure, and the optical joint where the two Si waveguides 23 near the input are connected to the input terminals of the LN waveguides 41 on the forward path and the optical joint where the two Si waveguides 24 near the output are connected to the output terminals of the LN waveguides 42 on the backward path are both located on the first end face 3A of the thin film LN chip 3. As a result, the work needed for adjustment of optical axes for, for example, tilting of the elements upon flip-chip bonding of the thin film LN chip 3 to the opening portion 13 of the SiPh chip 2 is able to be streamlined.

Electrodes 27 near the input and in the first oxide layer 12A are, for example, Al electrodes electrically connected to the RF electrodes 44 on the forward path in the thin film LN chip 3 via metal fusion bumps 55 of connection pads 54. Electrodes 28 near the output and in the first oxide layer 12A are, for example, Al electrodes electrically connected to the RF electrodes 45 on the backward path in the thin film LN chip 3 via bumps 55 of connection pads 54. That is, the RF electrodes in the thin film LN chip 3 have a return structure, the joint where the electrodes 27 near the input are electrically connected to the RF electrodes on the forward path and the joint where the electrodes 28 near the output are electrically connected the RF electrodes 45 on the backward path are both located on the first end face 3A of the thin film LN chip 3.

The optical modulator 1 according to the first embodiment has the optical joint where the Si waveguides 23 near the input are connected to the LN waveguides 42 on the forward path and the optical joint where the Si waveguides 24 near the output are connected to the LN waveguides 42 on the backward path, these optical joints both being located on the first end face 3A of the thin film LN chip 3. As a result, the adjustment of the optical axes between the SiN waveguides and the LN waveguides upon the flip-chip bonding of the thin film LN chip 3 to the opening portion 13 of the SiPh chip 2 is able to be all done on the first end face 3A and the mounting work is thus able to be streamlined.

Furthermore, the optical modulator 1 has the joint where the electrodes 27 near the input are connected to the RF electrodes 44 on the forward path and the joint where the electrodes 28 near the output are connected to the RF electrodes 45 on the backward path, these joints both being located on the first end face 3A of the thin film LN chip 3. As a result, the joints at the first end face 3A are fixed at one end of the thin film LN chip 3, influence of stress upon a temperature change due to a difference between thermal expansion coefficients of the thin film LN chip 3 and the SiPh chip 2 is thus reduced, and stability upon the operation is thereby able to be improved.

In the thin film LN chip 3, signal light guided through the LN waveguides 42 on the backward path, among the LN waveguides and the RF electrodes having the return structure, is subjected to high speed modulation according to the electric field from the RF electrodes 45 on the backward path. As a result, even in a case where LN waveguides of X-cut LN crystal are used, cancellation of modulation at the return is able to be prevented.

For convenience of description, in the case described above as an example, the signal light guided through the LN waveguides 42 on the backward path is subjected to the high speed modulation in the RF modulation unit 40 according to the electric field from the RF electrodes 45 on the backward path. However, the RF electrodes 44 on the forward path, instead of the RF electrodes 45 on the backward path, may be arranged such that an electric field is applied to the LN waveguides 41 on the forward path. In this case, signal light guided through the LN waveguides 41 on the forward path is able to be subjected to high speed modulation in the RF modulation unit 40 according to the electric field from the RF electrodes 44 on the forward path.

In the case described as an example with respect to the optical modulator 1 according to the first embodiment, the Si waveguides in the SiPh chip 2 and the LN waveguides in the thin film LN chip 3 are optically coupled to each other by the SiN waveguides 32. However, transition of optical power is caused by heat insulation conversion between the SiN waveguides 32 and the LN waveguides. Heat insulation conversion has high tolerance to misalignment between chips with respect to a light propagation direction but conversion efficiency may be deteriorated by misalignment between the chips with respect to a direction perpendicular to the light propagation direction, for example, differences from designed values for the intervals between the SiN waveguides 32 and the LN waveguides. An embodiment related to an optical modulator 1A that enables such deterioration to be addressed will hereinafter be described as a second embodiment.

### (c) Second Embodiment

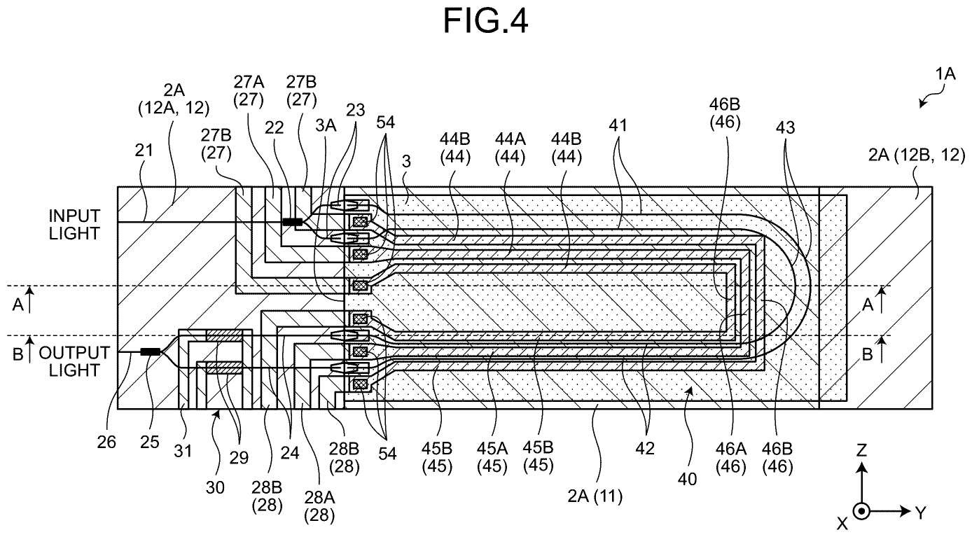

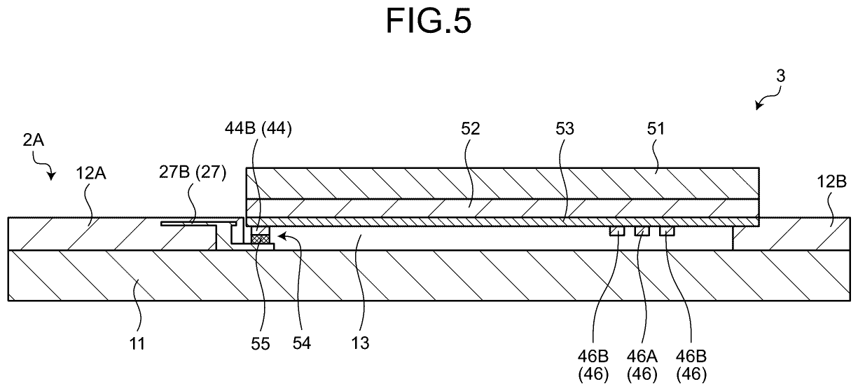

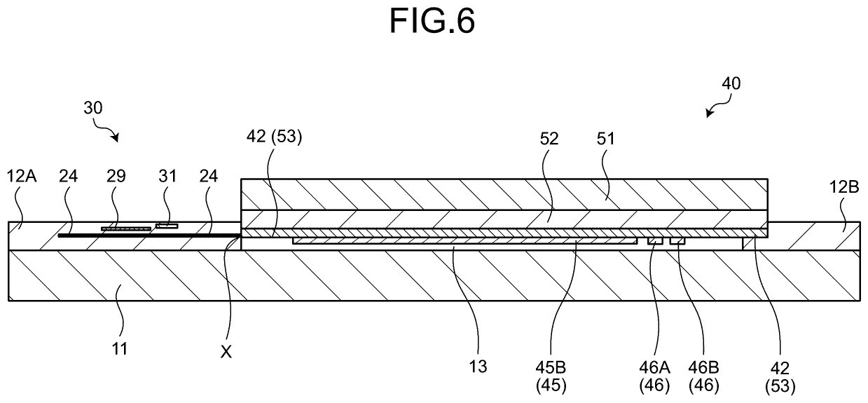

FIG. 4 is a planar schematic diagram illustrating an example of the optical modulator 1A according to the second embodiment, FIG. 5 is a sectional schematic diagram illustrating an example of a cross section on a line A-A illustrated in FIG. 4, and FIG. 6 is a sectional schematic diagram illustrating an example of a cross section on a line B-B illustrated in FIG. 4. By assignment of the same reference signs to components that are the same as those of the optical modulator 1 according to the first embodiment, description of the same components and operation thereof will be omitted. The optical modulator 1A according to the second embodiment is different from the optical modulator 1 according to the first embodiment in that butt coupling X, instead of the SiN waveguides 32, optically couples Si waveguides of a SiPh chip 2A and the LN waveguides of the thin film LN chip 3 to each other in the optical modulator 1A.

The two Si waveguides 23 near an input and in the SiPh chip 2A are optically coupled to the two LN waveguides 41 on the forward path of the thin film LN chip 3 by butt coupling X. Furthermore, the two Si waveguides 24 near an output of the SiPh chip 2A are optically coupled to the two LN waveguides 42 on the backward path of the thin film LN chip 3 by butt coupling X.

In the optical modulator 1A according to the second embodiment, the Si waveguides in the SiPh chip 2 and the LN waveguides in the thin film LN chip 3 are optically coupled to each other by the butt coupling X. As a result, in the optical modulator 1A, tolerance is able to be improved for misalignment between the chips in a direction perpendicular to a light propagation direction, not to mention misalignment between the chips in the light propagation direction.

In the case described as an example with respect to the optical modulator 1A according to the second embodiment, part of the oxide layer 12 of the SiPh chip 2A is subjected to etching and the opening portion 13 is thereby formed, and the thin film LN chip 3 is mounted in the opening portion 13. However, because the surface of the Si substrate 11 is exposed at the opening portion 13 of the SiPh chip 2A, an electric signal from the RF electrodes arranged on the thin film LN substrate 53 of the thin film LN chip 3 is thus absorbed by the Si substrate 11, and attenuation of the electric signal is thereby increased. Therefore, an embodiment related to an optical modulator 1B that enables such attenuation to be addressed will hereinafter be described as a third embodiment.

### (d) Third Embodiment

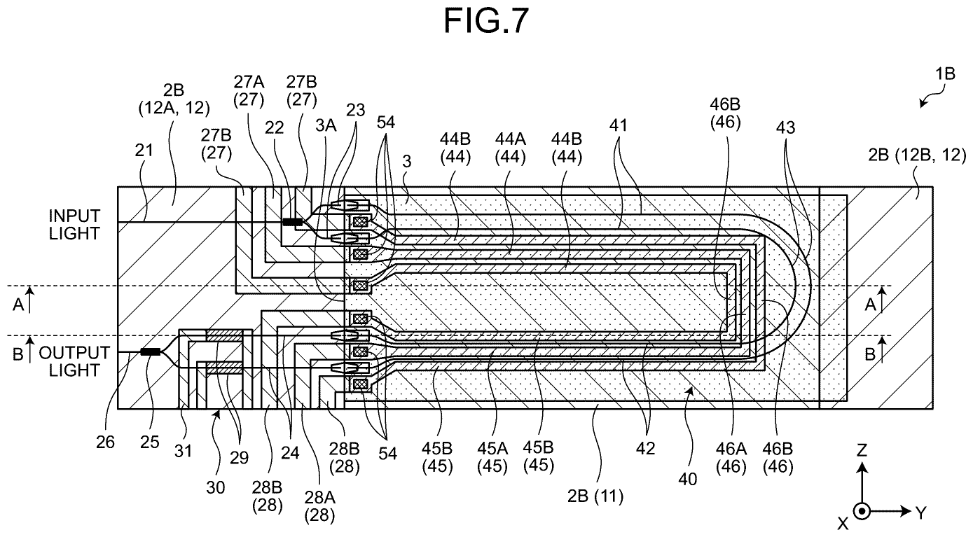

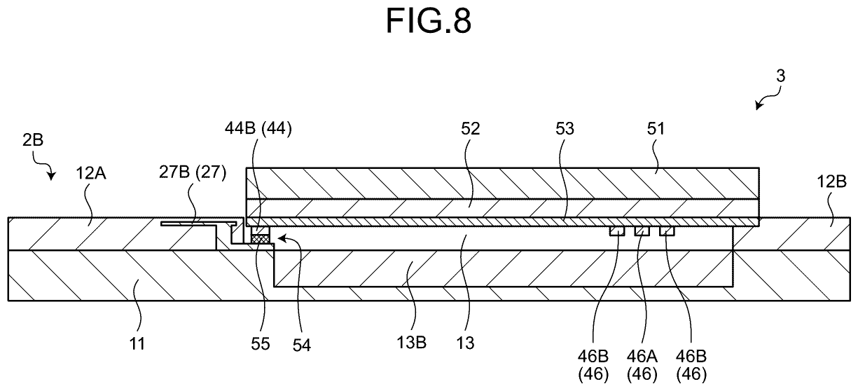

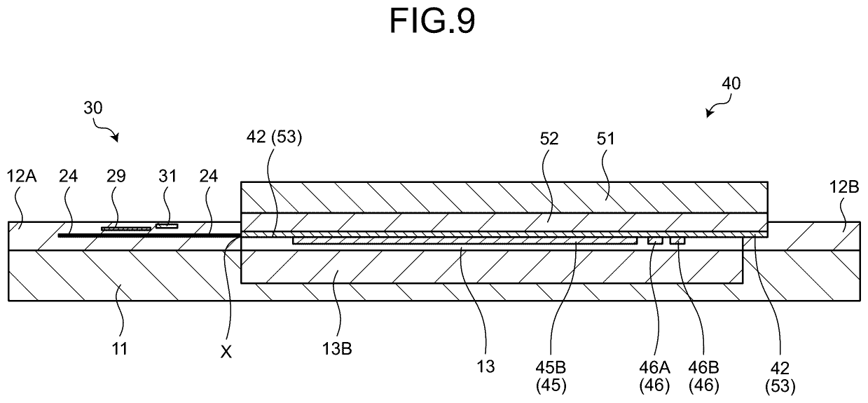

FIG. 7 is a planar schematic diagram illustrating an example of the optical modulator 1B according to the third embodiment, FIG. 8 is a sectional schematic diagram illustrating an example of a cross section on a line A-A illustrated in FIG. 7, and FIG. 9 is a sectional schematic diagram illustrating an example of a cross section on a line B-B illustrated in FIG. 7. By assignment of the same reference signs to components that are the same as those of the optical modulator 1A according to the second embodiment, description of the same components and operation thereof will be omitted. The optical modulator 1B according to the third embodiment is different from the optical modulator 1A according to the second embodiment in that a recessed portion 13B dug from and open on the surface of the Si substrate 11 has been formed, the surface being exposed from the opening portion 13 of a SiPh chip 2B, the opening portion 13 being where the thin film LN chip 3 is mounted.

An end face of the recessed portion 13B formed in the Si substrate 11 is structured to be coplanar with an end face of the first oxide layer 12A, the end face of the first oxide layer 12A being where the output terminals of the Si waveguides 23 that are near an input and that are in the SiPh chip 2B and the input terminals of Si waveguides 24 that are near an output and that are in the SiPh chip 2B are located.

The optical modulator 1B according to the third embodiment has the recessed portion 13B formed on the surface of the Si substrate 11, the surface being exposed from the opening portion 13 of the SiPh chip 2A. As a result, absorption of an electric signal by the Si substrate is able to be reduced and attenuation of the electric signal flowing to the RF electrodes is thus able to be reduced, the electric signal flowing to the RF electrodes arranged in the thin film LN substrate 53 of the thin film LN chip 3 mounted in the opening portion 13. Deterioration of RF characteristics is thus able to be reduced.

In the optical modulator 1B, to minimize increase in coupling loss due to misalignment of the chips at the joint where the Si waveguides in the SiPh chip 2B and the LN waveguides in the thin film LN chip 3 are optically coupled to each other by butt coupling X, confinement in the optical waveguides is weakened to increase the optical mode field. However, at the optical joint, radiation of light to the Si substrate 11 is large and the optical loss is increased. Therefore, an embodiment related to an optical modulator 1C that enables such increase in the optical loss to be addressed will hereinafter be described as a fourth embodiment.

### (e) Fourth Embodiment

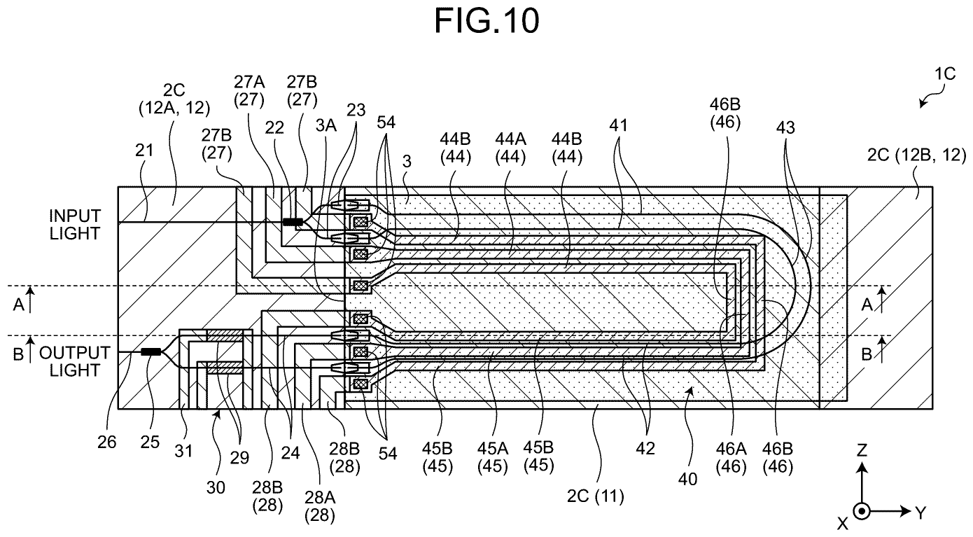

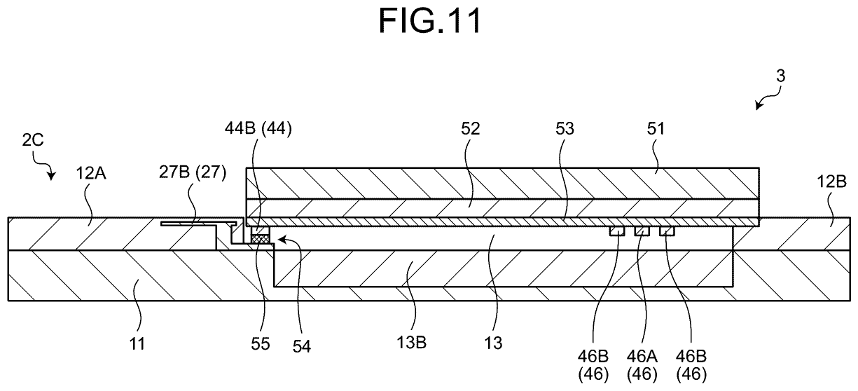

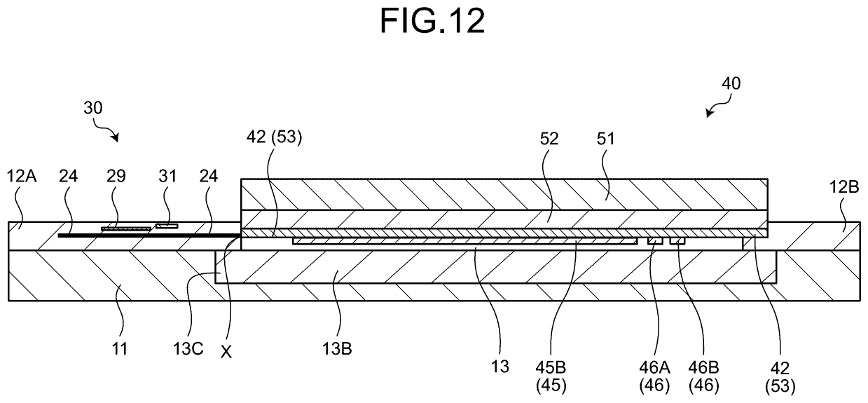

FIG. 10 is a planar schematic diagram illustrating an example of the optical modulator 1C according to the fourth embodiment, FIG. 11 is a sectional schematic diagram illustrating an example of a cross section on a line A-A illustrated in FIG. 10, and FIG. 12 is a sectional schematic diagram illustrating an example of a cross section on a line B-B illustrated in FIG. 10. By assignment of the same reference signs to components that are the same as those of the optical modulator 1B according to the third embodiment, description of the same components and operation thereof will be omitted. The optical modulator 1C according to the fourth embodiment is different from the optical modulator 1B in that in addition to the recessed portion 13B formed on the surface of the Si substrate 11, a recessed portion 13C has been formed in the optical modulator 1C, the recessed portion 13C having been additionally dug from part of the surface of the Si substrate 11, the part being underneath the optical joints between the Si waveguides of the first oxide layer 12A and the LN waveguides.

The recessed portion 13C has been formed in the opening portion 13 by being additionally dug from the part of the surface of the Si substrate 11, the part being near the optical joints where the Si waveguides 23 near the input and the LN waveguides 41 on the forward path are coupled to each other by butt coupling, that is, near the output terminals of the Si waveguides 23 that are near the input and that are in the first oxide layer 12A.

The recessed portion 13C has been formed in the opening portion 13 by being additionally dug from the part of the surface of the Si substrate 11, the part being near the optical joints where Si waveguides 24 near an output and LN waveguides 42 on a backward path are connected to each other by butt coupling, that is, near input terminals of the Si waveguides 24 near the output and in the first oxide layer 12A.

In the optical modulator 1C according to the fourth embodiment, the recessed portion 13C has been formed, in addition to the recessed portion 13B, in the opening portion 13 by additionally being dug from the part of the surface of the Si substrate 11, the part being underneath the optical joints between the Si waveguides in the first oxide layer 12A and the LN waveguides. As a result, radiation of light to the Si substrate 11 at the optical joints is able to be reduced and optical loss at the optical joints is thus able to be reduced.

In the case described as an example with respect to the optical modulator 1C according to the fourth embodiment, the Si waveguides in a SiPh chip 2C and the LN waveguides in the thin film LN chip 3 are optically coupled to each other by butt coupling X. However, if air gets in between the Si waveguides and the LN waveguides at the butt coupling X, reflection and loss of signal light guided are increased at the optical joints. Therefore, an embodiment related to an optical modulator 1D that enables such increase in the reflection and loss to be addressed will hereinafter be described as a fifth embodiment.

### (f) Fifth Embodiment

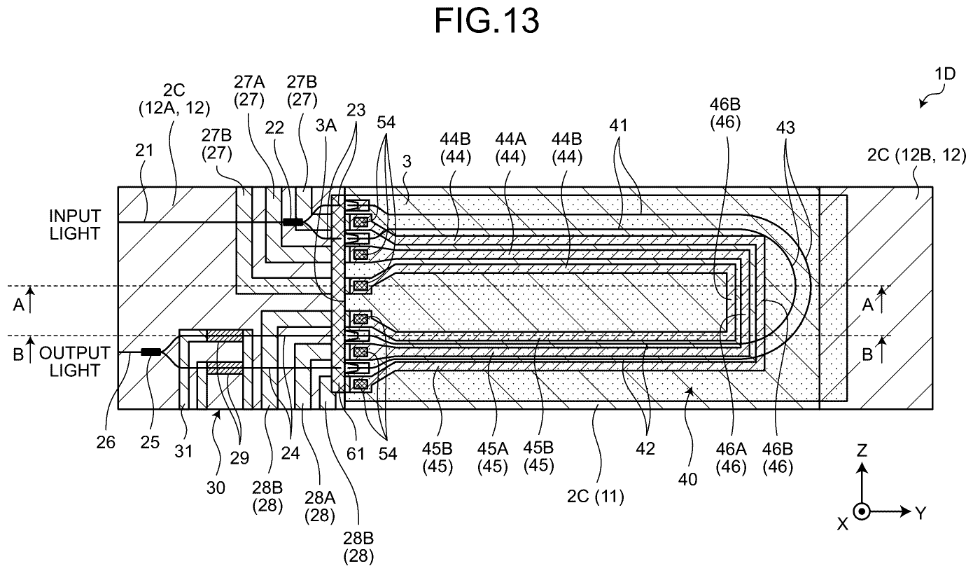

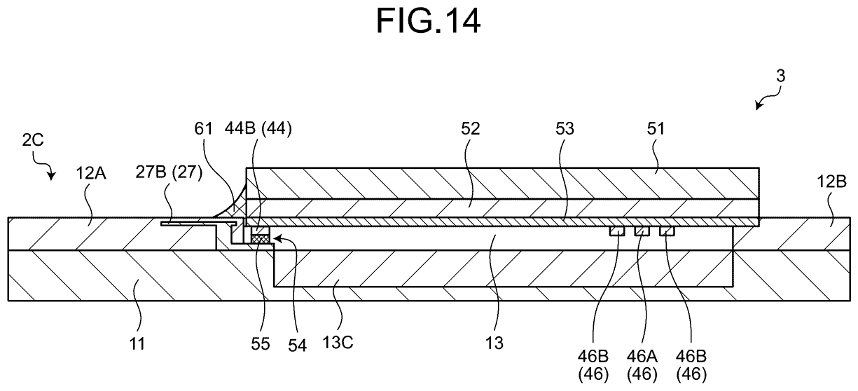

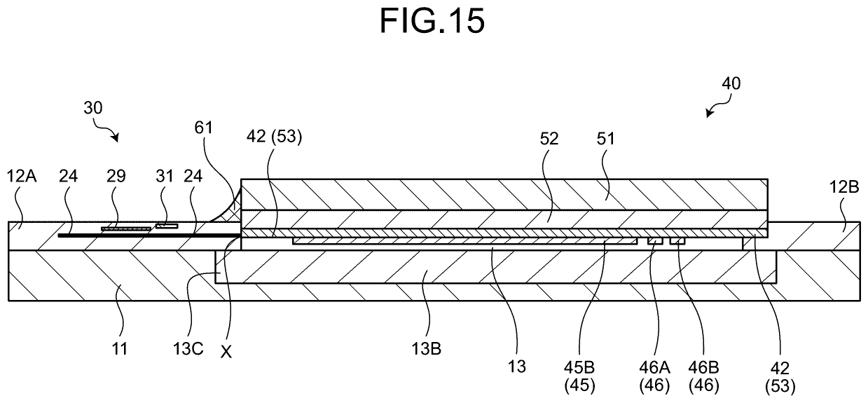

FIG. 13 is a planar schematic diagram illustrating an example of the optical modulator 1D according to the fifth embodiment, FIG. 14 is a sectional schematic diagram illustrating an example of a cross section on a line A-A illustrated in FIG. 13, and FIG. 15 is a sectional schematic diagram illustrating an example of a cross section on a line B-B illustrated in FIG. 13. By assignment of the same reference signs to components that are the same as those of the optical modulator 1C according to the fourth embodiment, description of the same components and operation thereof will be omitted. The optical modulator 1D according to the fifth embodiment is different from the optical modulator 1C according to the fourth embodiment in that the first oxide layer 12A in the SiPh chip 2C and the first end face 3A of the thin film LN chip 3 have been bonded to each other with an adhesive 61 for optics in the optical modulator 1D.

In the optical modulator 1D according to the fifth embodiment, the first oxide layer 12A in the SiPh chip 2C and the first end face 3A of the thin film LN chip 3 have been bonded to each other with the adhesive 61 for optics. As a result, air is able to be prevented from getting into the optical joints where the Si waveguides and the LN waveguides are optically coupled to each other by butt coupling X, and radiation and loss of light guided through the optical joints are thus able to be reduced.

However, because the SiPh chip 2C and the thin film LN chip 3 are bonded to each other with the adhesive 61 at the first end face 3A, that is, at one of end faces of the chip, the optical modulator 1D may be affected by an impact on or a vibration to the SiPh chip 2C and the thin film LN chip 3. Therefore, an embodiment related to an optical modulator 1E that enables such influence to be addressed will hereinafter be described as a sixth embodiment.

### (g) Sixth Embodiment

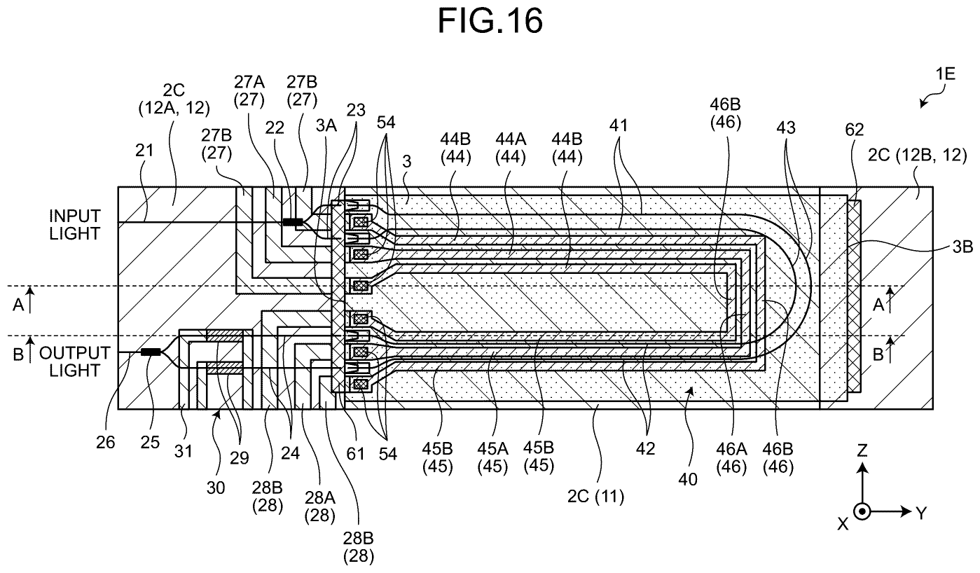

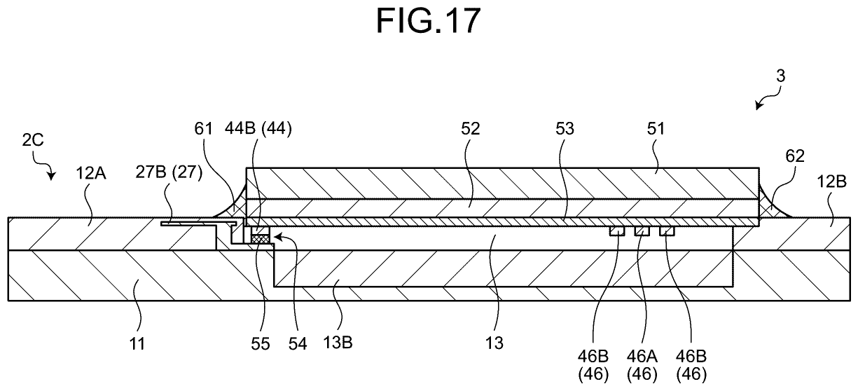

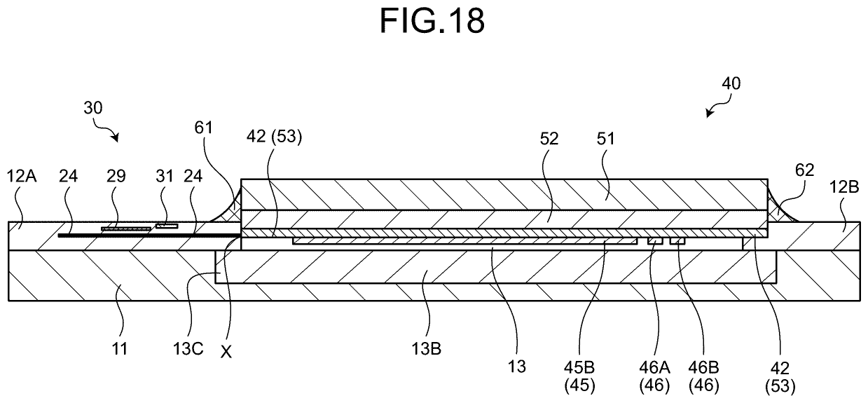

FIG. 16 is a planar schematic diagram illustrating an example of the optical modulator 1E according to the sixth embodiment, FIG. 17 is a sectional schematic diagram illustrating an example of a cross section on a line A-A illustrated in FIG. 16, and FIG. 18 is a sectional schematic diagram illustrating an example of a cross section on a line B-B illustrated in FIG. 17. By assignment of the same reference signs to components that are the same as those of the optical modulator 1D according to the fifth embodiment, description of the same components and operation thereof will be omitted. The optical modulator 1E according to the sixth embodiment is different from the optical modulator 1D according to the fifth embodiment in that the second oxide layer 12B and a second end face 3B of the thin film LN chip 3 have been bonded to each other with an adhesive 62, apart from the bonding between the first oxide layer 12A and the first end face 3A of the thin film LN chip 3, in the optical modulator 1E.

An adhesive softer than the adhesive 61 to bond between the first oxide layer 12A and the first end face 3A of the thin film LN chip 3 is used as the adhesive 62 for optics to bond between the second oxide layer 12B and the second end face 3B of the thin film LN chip 3. Hardness of the adhesive 62 after curing is smaller than hardness of the adhesive near the bump joints.

In the optical modulator 1E according to the sixth embodiment, the first oxide layer 12A and the first end face 3A of the thin film LN chip 3 have been bonded to each other with the adhesive 61 for optics, and the second oxide layer 12B and the second end face 3B of the thin film LN chip 3 have been bonded to each other with the adhesive 62. Furthermore, a material softer than the adhesive 61 is used as the adhesive 62. As a result, bonding between the SiPh chip 2C and the thin film LN chip 3 at both ends enables reduction in influence of an impact on or a vibration to the SiPh chip 2C and the thin film LN chip 3. What is more, because a softer material is used as the adhesive 62 used at one end, stress on the thin film LN chip 3 is able to be reduced and operation of the optical modulator 1E is thus able to be stabilized.

The same adhesive may be used as the adhesive 61 for optics to bond between the first oxide layer 12A and the first end face 3A and the adhesive 62 to bond between the second oxide layer 12B and the second end face 3B, if the stress on the thin film LN chip 3 is thereby able to be reduced.

In the case described as an example with respect to the optical modulator 1E according to the sixth embodiment, the SiPh chip 2 is bonded at the first end face 3A of the thin film LN chip 3 and the second end face 3B opposite to the first end face 3A. However, the example may be modified as appropriate without being limited to the second end face 3B, and instead of the second end face 3B, an end face orthogonal to the first end face 3A of the thin film LN chip 3 may be bonded to the SiPh chip 2.

Furthermore, in the example described with respect to the optical modulator 1E according to the sixth embodiment, the three connection pads 54 are connected to the electrodes 27 near the input and to the RF electrodes 44 on the forward path, and the three connection pads 54 electrically connects the electrodes 28 near the output and the RF electrodes 45 on the backward path to each other. However, the number of connection pads 54 may be decreased and such an embodiment will hereinafter be described as a seventh embodiment.

### (h) Seventh Embodiment

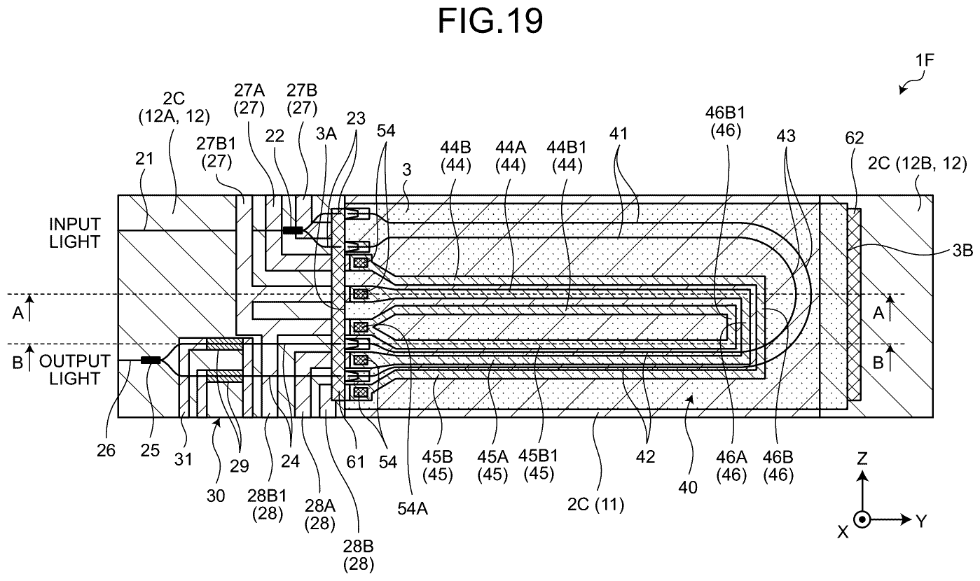

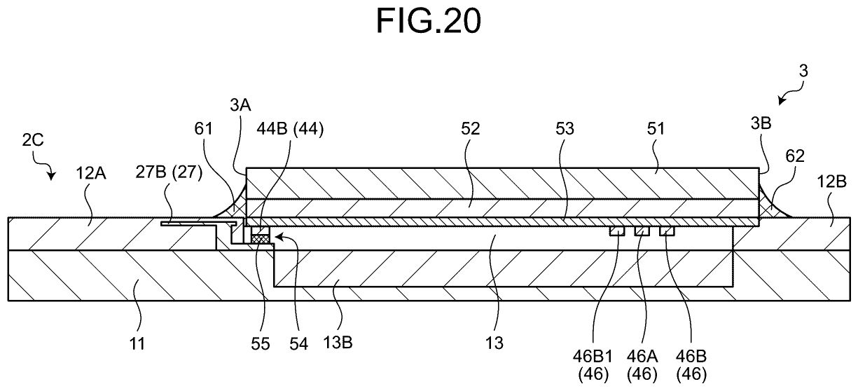

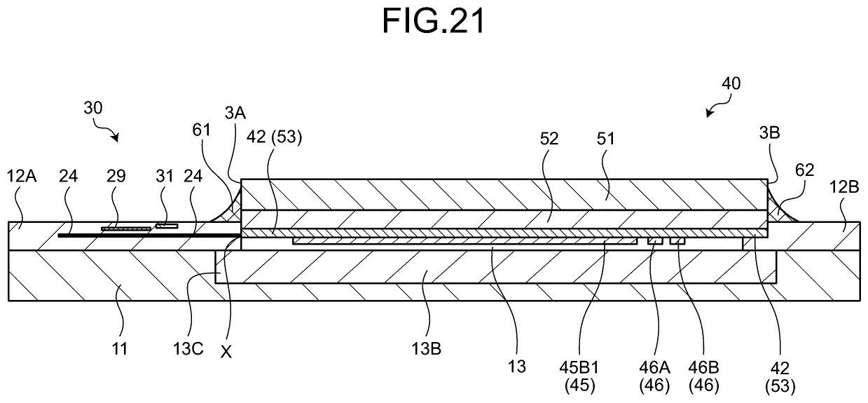

FIG. 19 is a planar schematic diagram illustrating an example of an optical modulator 1F according to the seventh embodiment, FIG. 20 is a sectional schematic diagram illustrating an example of a cross section on a line A-A illustrated in FIG. 19, and FIG. 21 is a sectional schematic diagram illustrating an example of a cross section on a line B-B illustrated in FIG. 19. By assignment of the same reference signs to components that are the same as those of the optical modulator 1E according to the sixth embodiment, description of the same components and operation thereof will be omitted. The optical modulator 1F according to the seventh embodiment is different from the optical modulator 1E according to the sixth embodiment in that a ground electrode 27B1 of the electrodes 27 near the input and a ground electrode 28B1 of the electrodes 28 near the output have been connected to a shared pad 54A, instead of the connection pads 54.

The shared pad 54A electrically connects between the ground electrode 27B1 of the electrodes 27 near the input and a ground electrode 44B1 of the RF electrodes 44 on the forward path. The shared pad 54A also electrically connects between the ground electrode 28B1 of the electrodes 28 near the output and a ground electrode 45B1 of the RF electrodes 45 on the backward path. A ground electrode 46B1 of the return RF electrodes 46 electrically connects between the ground electrode 44B1 of the RF electrodes 44 on the forward path and the ground electrode 45B1 of the RF electrodes 45 on the backward path.

The optical modulator 1F has the connection pad 54 that connects a ground electrode 27B of the electrodes 27 near the input and the ground electrode 44B of the RF electrodes 44 on the forward path to each other, and the connection pad 54 that connects a signal electrode 27A of the electrodes 27 near the input and the signal electrode 44A of the RF electrodes 44 on the forward path to each other. The optical modulator 1F also has the connection pad 54 that connects a ground electrode 28B of the electrodes 28 near the output and the ground electrode 45B of the RF electrodes 45 on the backward path to each other, and the connection pad 54 that connects a signal electrode 28A of the electrodes 28 near the output and the signal electrode 45A of the RF electrodes 45 on the backward path to each other. The optical modulator 1F also has the shared pad 54A connecting the ground electrode 27B1 of the electrodes 27 near the input and the ground electrode 44B1 of the RF electrodes 44 on the forward path to each other and connecting the ground electrode 28B1 of the electrodes 28 near the output and the ground electrode 45B1 of the RF electrodes 45 on the backward path to each other.

In the optical modulator 1F according to the seventh embodiment, the ground electrode 27B1 of the electrodes 27 near the input and the ground electrode 28B1 of the electrodes 28 near the output have been connected to the shared pad 54A. As a result, the number of connection pads to electrically connect between the SiPh chip 2C and the thin film LN chip 3 is able to be decreased to five, stress on the bump joints is able to be reduced, and the chips are thereby able to be downsized.

The inner waveguide and the outer waveguide have different waveguide lengths because the two Si waveguides and the two LN waveguides included in the Mach-Zehnder interferometer are turned back in the optical modulator 1F according to the seventh embodiment, and temperature characteristics and wavelength characteristics of the optical modulator 1F are thereby affected. Therefore, an embodiment to address such influence will hereinafter be described as an eighth embodiment.

### (i) Eighth Embodiment

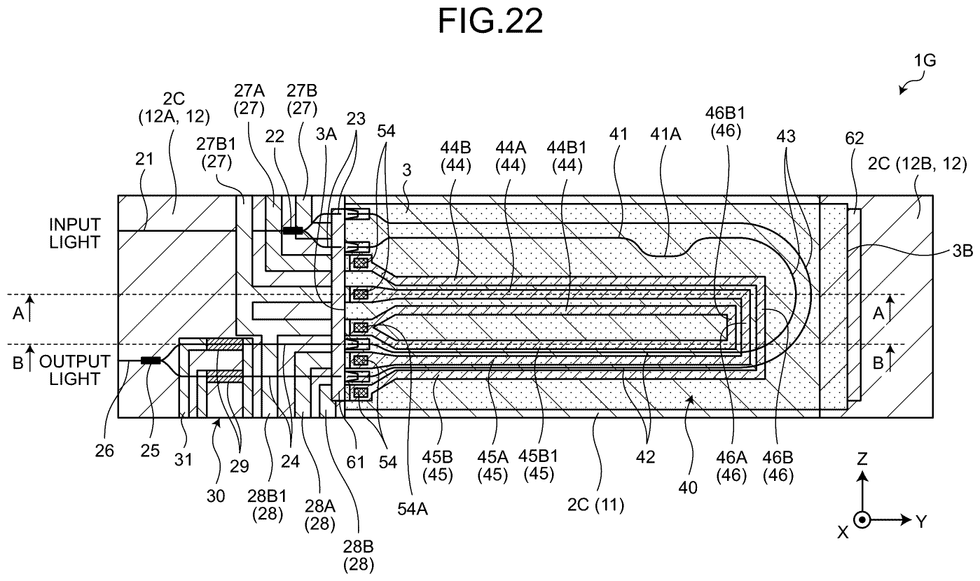

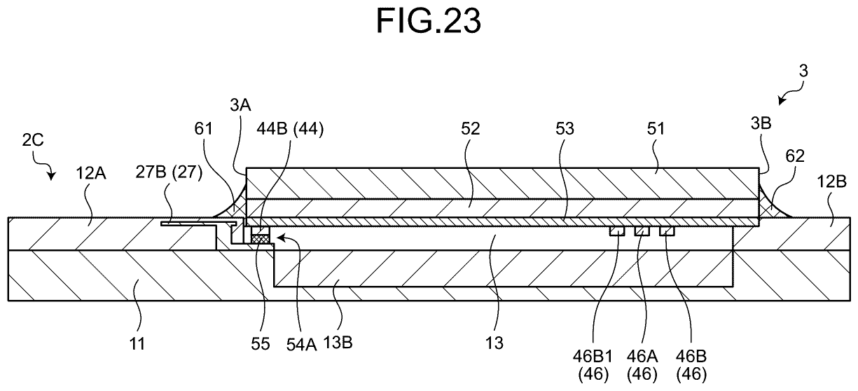

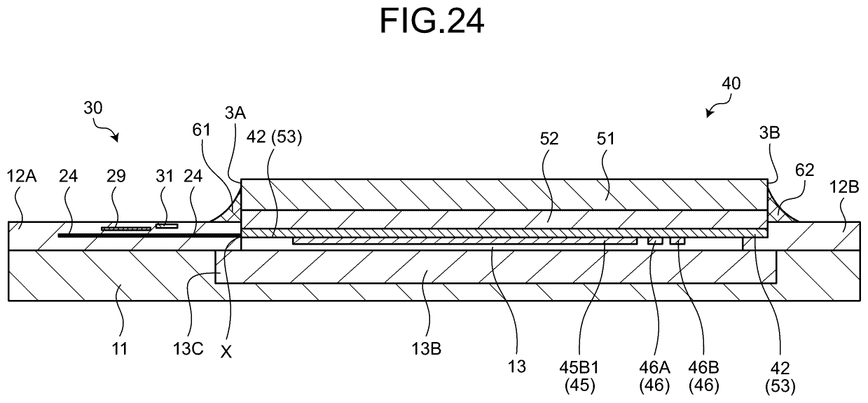

FIG. 22 is a planar schematic diagram illustrating an example of an optical modulator 1G according to the eighth embodiment, FIG. 23 is a sectional schematic diagram illustrating an example of a cross section on a line A-A illustrated in FIG. 22, and FIG. 24 is a sectional schematic diagram illustrating an example of a cross section on a line B-B illustrated in FIG. 22. By assignment of the same reference signs to components that are the same as those of the optical modulator 1F according to the seventh embodiment, description of the same components and operation thereof will be omitted. The optical modulator 1G according to the eighth embodiment is different from the optical modulator 1F according to the seventh embodiment in that the inner LN waveguide 41 on the forward path among the two LN waveguides 41 on the forward path has been replaced, in the optical modulator 1G, by a bent waveguide 41A having a waveguide length adjusted from that of the inner LN waveguide 41 on the forward path. The bent waveguide 41A makes the waveguide length of the inner LN waveguide having the return structure and the waveguide length of the outer LN waveguide having the return structure the same.

The inner LN waveguide included in the Mach-Zehnder interferometer is an LN waveguide including the inner LN waveguide 41 on the forward path, the inner LN waveguide 42 on the backward path, and the inner return LN waveguide 43. The outer LN waveguide included in the Mach-Zehnder interferometer is an LN waveguide including the outer LN waveguide 41 on the forward path, the outer LN waveguide 42 on the backward path, and the outer return LN waveguide 43.

The inner LN waveguide 41 on the forward path has been replaced by the bent waveguide 41A so that the inner LN waveguide and the outer LN waveguide in the thin film LN chip 3 have the same waveguide length. That is, the bent waveguide 41A has made the waveguide length of one the two LN waveguides 41 on the forward path longer or shorter than the waveguide length of the other one of the two LN waveguide 41 on the forward path. As a result, the waveguide length of the inner LN waveguide and the waveguide length of the outer LN waveguide have become the same.

In the optical modulator 1G according to the eighth embodiment, the inner LN waveguide 41 on the forward path in the thin film LN chip 3 has been replaced by the bent waveguide 41A so that the inner LN waveguide and the outer LN waveguide have the same waveguide length. As a result, the waveguide length of the inner LN waveguide included in the Mach-Zehnder interferometer and the waveguide length of the outer LN waveguide included in the Mach-Zehnder interferometer become the same and the influence on temperature characteristics and wavelength characteristic of the optical modulator 1G is able to be reduced.

In the case described as an example with respect to the optical modulator 1G according to the eighth embodiment, the waveguide length of the LN waveguide 41 on the forward path is adjusted, but the example may be modified as appropriate and the waveguide length of the return LN waveguide 43, instead of the LN waveguide 41 on the forward path, may be adjusted.

Furthermore, in the case described as an example with respect to the optical modulator 1G, the waveguide length of the LN waveguide 41 on the forward path is adjusted to make the waveguide length of the inner LN waveguide and the waveguide length of the outer LN waveguide the same. However, an embodiment not limited to this example will hereinafter be described as a ninth embodiment.

### (j) Ninth Embodiment

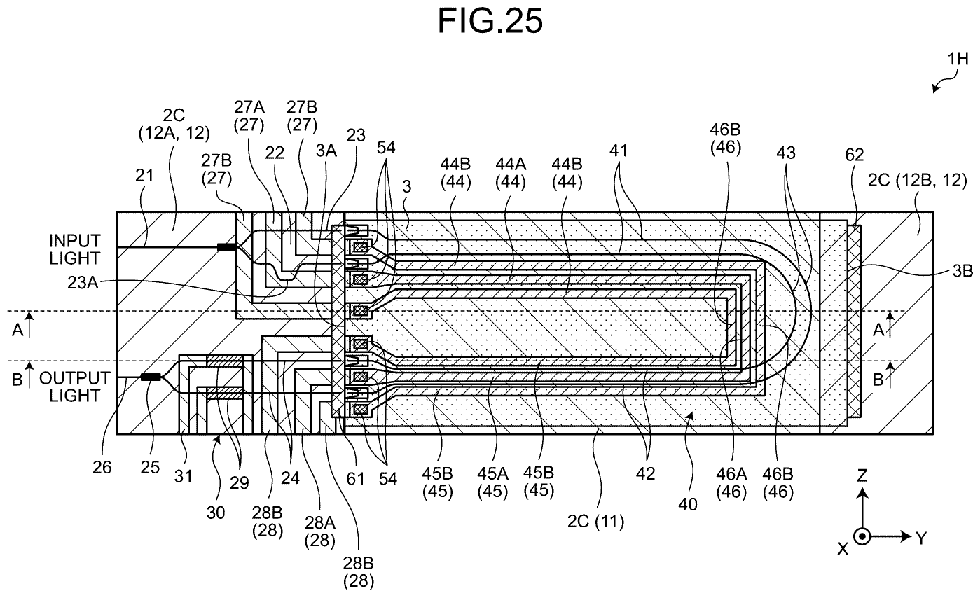

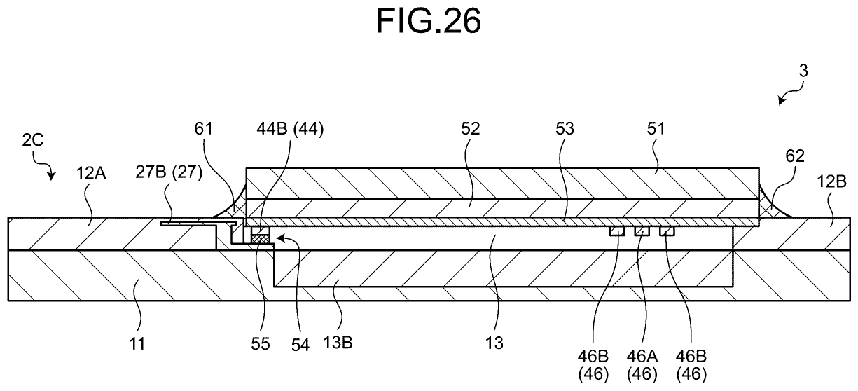

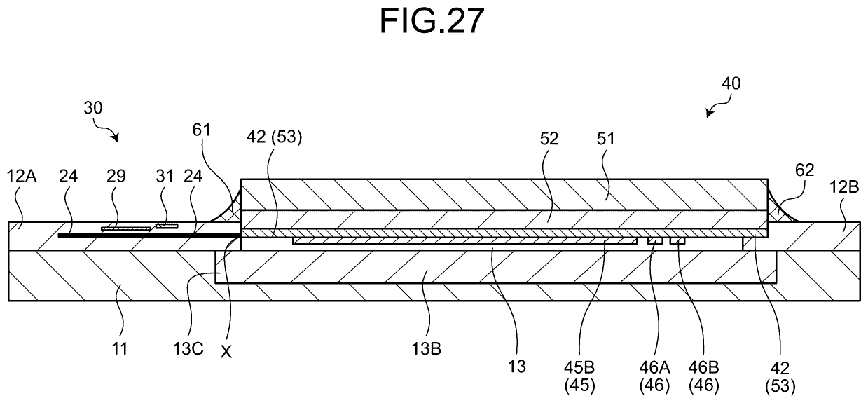

FIG. 25 is a planar schematic diagram illustrating an example of an optical modulator 1H according to the ninth embodiment, FIG. 26 is a sectional schematic diagram illustrating an example of a cross section on a line A-A illustrated in FIG. 25, and FIG. 27 is a sectional schematic diagram illustrating an example of a cross section on a line B-B illustrated in FIG. 25. By assignment of the same reference signs to components that are the same as those of the optical modulator 1E according to the sixth embodiment, description of the same components and operation thereof will be omitted. The optical modulator 1H according to the ninth embodiment is different from the optical modulator 1E according to the sixth embodiment in that the inner Si waveguide 23 near the input, among the two Si waveguides 23 near the input, has been replaced, in the optical modulator 1H, by a bent waveguide 23A having a waveguide length adjusted from that of the inner Si waveguide 23 near the input. The bent waveguide 23A makes an inner waveguide and an outer waveguide of a return structure have the same waveguide length.

The inner waveguide included in the Mach-Zehnder interferometer is a waveguide including the inner Si waveguide 23 near the input, the inner LN waveguide 41 on the forward path, the inner LN waveguide 42 on the backward path, the inner return LN waveguide 43, and the inner Si waveguide 24 near the output. The outer waveguide included in the Mach-Zehnder interferometer is a waveguide including the outer Si waveguide 23 near the input, the outer LN waveguide 41 on the forward path, the outer LN waveguide 42 on the backward path, the outer return LN waveguide 43, and the outer Si waveguide 24 near the output.

This inner Si waveguide 23 near the input has been replaced by the bent waveguide 23A so that the inner waveguide and the outer waveguide have the same waveguide length. The bent waveguide 23A has made one of the two Si waveguides 23 near the input longer or shorter in waveguide length than the other one of the two Si waveguides 23 near the input. As a result, the waveguide length of the inner LN waveguide and the waveguide length of the outer LN waveguide have become the same. A Si waveguide of the SiPh chip 2C is able to be formed into a bent waveguide at a smaller bending radius than an LN waveguide of the thin film LN chip 3.

In the optical modulator 1H according to the ninth embodiment, the inner Si waveguide 23 near the input has been replaced by the bent waveguide 23A so that the inner waveguide and the outer waveguide have the same waveguide length. As a result, the waveguide length of the inner waveguide included in the Mach-Zehnder interferometer and the waveguide length of the outer waveguide included in the Mach-Zehnder interferometer become the same and the influence on temperature characteristics and wavelength characteristic of the optical modulator 1H is able to be reduced.

In the case described as an example with respect to the optical modulator 1G according to the ninth embodiment, the waveguide length of the inner Si waveguide 23 near the input is adjusted, but this example may be modified as appropriate, and the waveguide length of the inner Si waveguide 24 near the output may be adjusted instead.

The optical modulator 1 has been described as an example of an optical device according to the present invention, but without being limited to the optical modulator 1, the optical device may be any one of various optical devices including optical receivers.

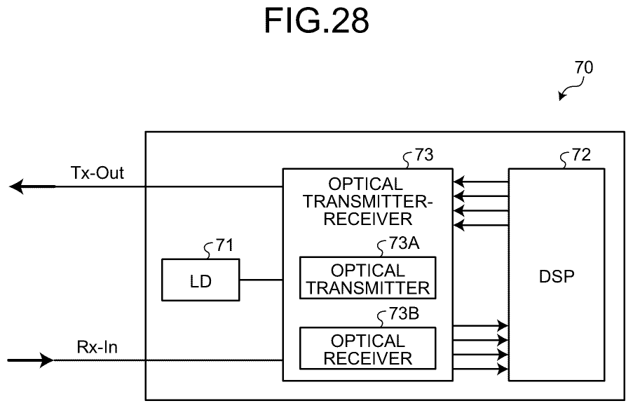

FIG. 28 is a diagram illustrating an example of an optical transceiver 70 according to an embodiment. The optical transceiver 70 illustrated in FIG. 28 is connected to an optical fiber near an output and an optical fiber near an input. The optical transceiver 70 has a light source 71, a digital signal processor (DSP) 72, and an optical transmitter-receiver 73. The optical transmitter-receiver 73 has an optical transmitter 73A and an optical receiver 73B. The DSP 72 is an electric component that executes digital signal processing. For example, the DSP 72 executes processing, such as encoding of transmitted data, generates an electric signal including the transmitted data, and outputs the electric signal generated, to the optical transmitter 73A. Furthermore, the DSP 72 obtains an electric signal including received data from the optical receiver 73B, executes processing, such as decoding of the electric signal obtained, and thereby obtains the received data.

The light source 71 is, for example, an LD that includes a laser diode, generates light having a predetermined wavelength, and supplies the light to the optical transmitter 73A and the optical receiver 73B. The optical transmitter 73A is an optical device, such as an optical modulator that modulates the light supplied from the light source 71 using the electric signal output from the DSP 72 and outputs the signal light modulated, to the optical fiber. The optical transmitter 73A has, for example, an optical device, such as an optical modulator, built therein, the optical modulator including the SiPh chip 2 and the thin film LN chip 3. When the light supplied from the light source 71 is guided through waveguides in the optical transmitter 73A, signal light is generated by modulation of this light by means of the electric signal.

The optical receiver 73B receives received light from the optical fiber, converts the received light into an electric signal by using the light supplied from the light source 71, and outputs the electric signal converted, to the DSP 72.

In the case described above as an example, the optical transceiver 70 has the optical transmitter 73A and the optical receiver 73B built therein, but the present invention is applicable to an optical transmitter having only the optical transmitter 73A built therein, the optical transmitter 73A having the optical device built therein. Furthermore, the present invention is also applicable to an optical receiver having only the optical receiver 73B built therein, the optical receiver 73B having an optical device built therein. An optical device according to the present invention is also applicable to the optical transmitter-receiver 73 without being limited to the optical transceiver 70.

The thin film LN chip 3 has been described as an example with respect to the embodiments, but without being limited to this example, the example may be modified as appropriate and TF-barium titanate may be used, for example. Examples of a material having an electro-optical effect include BaTiO₃ (TF-BTO), PbLaZrTiO₃ (TF-PLZT), and PbZrTiO₃ (TF-PZT), and the material may be modified as appropriate.

According to an embodiment related to, for example, an optical device disclosed by the present application, an optical device is able to be provided, the optical device including: a first chip including a first electrode; and a second chip including a second electrode.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a first chip including a first waveguide and a first electrode; and
a second chip mounted on the first chip and including a second waveguide and a second electrode, wherein
the second waveguide has an electro-optical effect higher than an electro-optical effect of the first waveguide, has a return structure that places an end of the second waveguide at an end face of the second chip, and is optically coupled to the first waveguide at the end face, and
the second electrode has a return structure that places an end of the second electrode at the end face, and the second electrode and the first electrode are electrically connected to each other in an area where the end of the second electrode has been placed.

2. The optical device according to claim 1, wherein
the second waveguide having the return structure has a second waveguide on a forward path and a second waveguide that is on a backward path and that is connected to the second waveguide on the forward path,
the second electrode having the return structure has a second electrode on a forward path and a second electrode on a backward path,
the second electrode on the backward path has been arranged to apply an electric field from the second electrode on the backward path to the second waveguide on the backward path, and
the second electrode on the forward path has been arranged to not apply an electric field from the second electrode on the forward path to the second waveguide on the forward path.

3. The optical device according to claim 1, wherein the first chip has been bonded to the end face of the second chip with an adhesive.

4. The optical device according to claim 3, wherein the first chip has been bonded to another end face of the second chip with another adhesive softer than the adhesive, the another end face being other than the end face.

5. The optical device according to claim 1, wherein
the second waveguide having the return structure has a second waveguide on a forward path and a second waveguide that is on a backward path and that is connected to the second waveguide on the forward path,
the second electrode having the return structure has a second electrode on a forward path and a second electrode on a backward path,
the second waveguide on the forward path includes two waveguides on the forward path,
the second waveguide on the backward path includes two waveguides on the backward path, the two waveguides being connected to the two waveguides on the forward path, and
one of the two waveguides on the forward path has a waveguide length that has been made the same as a waveguide length of the other one of the two waveguides on the forward path.

6. The optical device according to claim 1, wherein
the first waveguide has a first waveguide near an input and a first waveguide near an output,
the first waveguide near the input includes two waveguides near the input,
the first waveguide near the output includes two waveguides near the output,
the second waveguide having the return structure has a second waveguide on a forward path and a second waveguide that is on a backward path and that is connected to the second waveguide on the forward path,
the second waveguide on the forward path includes two waveguides on the forward path,
the second waveguide on the backward path includes two waveguides on the backward path, the two waveguides being connected to the two waveguides on the forward path, and
one of the two waveguides near the input has a waveguide length that is the same as a waveguide length of the other one of the two waveguides near the input, or one of the two waveguides near the output has a waveguide length that is the same as a waveguide length of the other one of the two waveguides near the output.

7. The optical device according to claim 1, wherein
the first waveguide has two first waveguides near an input and two first waveguides near an output,
the second waveguide has two second waveguides on a forward path and two second waveguides on a backward path, and
the optical device includes:
a splitter that splits light input to the splitter;
the two first waveguides that are connected to the splitter and that are near an input;
the two second waveguides on the forward path and connected to the two first waveguides near the input;
the two second waveguides on the backward path and connected to the two second waveguides on the forward path;
second electrodes that apply a second electric signal to the two second waveguides on the backward path;
the two first waveguides near the output and connected to the two second waveguides on the backward path;
first electrodes that apply a first electric signal to the two first waveguides near the output; and
a multiplexer that is connected to the two first waveguides near the output, multiplexes light modulated through the two first waveguides near the output according to the first electric signal together, and outputs the light that has been multiplexed, to an output unit, wherein
the first chip is a silicon photonics chip and has the splitter, the two first waveguides near the input, the two first waveguides near the output, the first electrodes, and the multiplexer, and
the second chip is a thin film LN chip and has the two second waveguides on the forward path, the two second waveguides on the backward path, and the second electrodes.

8. The optical device according to claim 1, wherein in a case where an electro-optical crystal layer of the second chip is an X-cut thin film LN chip, the second waveguide is an optical waveguide where light propagates in a Y-axis direction along a crystal axis of the X-cut thin film LN chip.

9. An optical transmitter comprising
a light source that emits light; and
an optical device that modulates the light from the light source according to an electric signal, wherein
the optical device includes:
a first chip including a first waveguide and a first electrode; and
a second chip mounted on the first chip and including a second waveguide and a second electrode,
the second waveguide has an electro-optic effect higher than an electro-optic effect of the first waveguide, has a return structure that places an end of the second waveguide at an end face of the second chip, and is optically coupled to the first waveguide at the end face, and
the second electrode has a return structure that places an end of the second electrode at the end face, and the second electrode and the first electrode are electrically connected to each other in an area where the end of the second electrode has been placed.

10. An optical transceiver comprising:
a processor that executes signal processing of an electric signal;
a light source that generates light;
an optical device that modulates the light generated by the light source by using the electric signal output from the processor; and
an optical receiver that converts received light into an electric signal by using the light generated by the light source, wherein
the optical device includes:
a first chip including a first waveguide and a first electrode; and
a second chip mounted on the first chip and including a second waveguide and a second electrode,
the second waveguide has an electro-optic effect higher than an electro-optic effect of the first waveguide, has a return structure that places an end of the second waveguide at an end face of the second chip, and is optically coupled to the first waveguide at the end face, and
the second electrode has a return structure that places an end of the second electrode at the end face, and the second electrode and the first electrode are electrically connected to each other in an area where the end of the second electrode has been placed.
